(19) United States
(12) Patent Application Publication
(10) Pub. No.: US 2002/0148308 A1
(43) Pub. Date: Oct. 17, 2002

(54) Gyroscope based propulsion apparatus

(76) Inventor: Alvaro Rush, Barrington, IL (US)

Correspondence Address: Richard W. Goldstein, 2071 Clove Road, Staten Island, NY, 10304, US

(21) Appl. No.: 09/791,285

(22) Filed: Feb. 23, 2001

(51) Int. Cl. F16H 27/04

(52) U.S. Cl. 74/84 S

(57) ABSTRACT

A vehicle propulsion platform includes a plurality of anti-gravity clusters arranged in a circular pattern and suitably fixed to a base platform. Each anti-gravity cluster includes a plurality of magnetic gyroscopic elements that are fixed at a selected angle upon a cluster disk of the respective anti-gravity cluster. The anti-gravity cluster is structured so that the cluster disk is controllably rotatable about a rotational axis, wherein gyroscopic procession is employed to induce lifting and maneuvering of the propulsion platform.

### TECHNICAL FIELD

The present invention relates most generally to propulsion systems. More particularly, the invention provides an advanced propulsion system employing gyroscopic propulsion principles.

### BACKGROUND ART

The need for advanced propulsion systems that are clean and environmentally safe is well understood. At present, methods and means that provide the greatest promise include fuel cells and gyroscopic precession based approaches.

Fuel cells provide high power densities and as such are desirable. A well known type of fuel cell utilizes hydrogen and oxygen as a fuel, and produces only water as an ‘exhaust’ by-product. Hybrid and electric vehicles are strong candidates for use with fuel cells. Given the power densities, especially as a function of weight, hydrogen fuel cells provide an excellent power source for these aforementioned types of propulsion systems. However, as skilled persons will appreciate, a major concern of this promising power technology is the well known volatility of hydrogen. A small leak in the vicinity of a suitable ignition source can spell disaster. Gyroscopic propulsion systems employ rotating masses that enable rotational energy to be converted to linear motion. As such, one or more gyroscopic elements are employed to generate rotational motion and energy, which is converted to linear motion in a selected direction. For example, the utility patent (U.S. Pat. No. 5,860,317) to Laithwaite et al., discloses a simple device employing gyroscopic propulsion wherein a mass undergoes linear motion along a track-like guide member. It may be noted that many experts believe gyroscopic propulsion systems may be a most promising future avenue to high speed, efficient transportation.

Therefore, skilled individuals will understand a need for improved and efficient propulsion systems to enable transport of cargo and individuals in an environmentally sound manner. In particular, there is a need for improved propulsion means and methods that are not based upon fossil-fuel burning constructions, and essentially don't pollute. A full understanding of the present invention, including an understanding of a number of capabilities, characteristics, and associated novel features, will result from a careful review of the description and figures of several embodiments provided herein. Attention is called to the fact, however, that the drawings and descriptions are illustrative only. Variations and alternate embodiments are contemplated as being part of the invention, limited only by the scope of the appended claims.

### SUMMARY OF THE INVENTION

In accordance with the present invention, an anti-gravity propulsion platform is structured to enable a base platform and additional structures and masses fixed to the base platform to rise and maneuver in a controlled manner. The additional structures and masses may include cargo, personal belongings, one or more passengers and or an operator such as a pilot. The propulsion platform preferably includes a base platform having a substantially flattened and circular shape. The propulsion platform may most preferably be provided by a complicated chassis that is composed of numerous members. A plurality of spaced anti-gravity clusters may be uniformly positioned in annular relationship with substantially equal circumferential spacing. Each anti-gravity cluster is most preferably positioned at an equi-distant radius from a ‘center location’ of the base platform. It may be noted that this center location may be provided as a center of mass, a center of gravity, or another suitable location near a center region of the base platform.

Each of the anti-gravity clusters is configured having a cluster disk that is rotatably fixed or coupled to the base platform. Accordingly, a cluster disk is structured with a suitable support and mounting arrangement that would include friction reducing members, such as bearings, etc, to enable the cluster disk to be rotated in one of either a clockwise or a counter clockwise direction. The rotation of the cluster disk is most preferably about a rotational axis that is substantially orthogonal to a plane established by the base platform.

Each of the plurality of anti-gravity clusters includes a plurality of magnetic gyroscope elements. The magnetic gyroscope elements are arranged in annular relationship at a substantially equi-distant radius from a center location of each cluster disk. In addition, the magnetic gyroscope elements are each fixed to the cluster disk such that a rotational axis of each magnetic gyroscope element is aligned and oriented substantially with a 45 degree angle. The 45 degree angle is established between a plane of the cluster disk and a rotational axis of each magnetic gyroscope element. As such, preferred embodiments of the present invention provide for cluster disks that are spinning about a rotational axis that is orthogonal to a surface of the base platform or chassis, while magnetic gyroscope elements are simultaneously spinning about a spin or rotational axis that is maintained at a selected, possibly adjustable tilt angle. For example, a preferred range of tilt angles may be 30 to 60 degrees, with a most preferred tilt angle being 45 degrees. The tilt angle of a magnetic gyroscope element is measured between the rotational axis thereof and a plane of the base platform (and the rotating anti-gravity cluster disks).

The magnetic gyroscope elements each include a magnetic disk which is rotatably supported within the magnetic gyroscope element. It may be noted that the rotational axis of each magnetic gyroscope element is established by a rotational axis of each magnetic disk—of a respective magnetic gyroscope element. Importantly, a plurality of permanent magnets are situated at spaced locations around an outer rim portion of the magnetic disk. Each of these permanent magnets is located and fixed at the outer rim portion of the magnetic disks, preferably at circumferentially spaced locations. Alternately, the permanent magnets may be provided as an annular arrangement of possibly segmented permanent magnets, which forms a rotating magnetic ring structure. A second plurality of fixed permanent magnets may be included with each magnetic gyroscope element. Each of the second group of permanent magnets may most preferably be fixed to, or mounted upon a circumferential support member of the magnetic gyroscope element. As the circumferential support members are situated at the spaced locations about the circumference of a respective magnetic disk, the permanent magnets fixed to the circumferential support members are therefore also positioned at circumferentially spaced locations. These spaced locations are further established and positioned adjacent to the magnetic disk so that a small gap exists between the rotating magnets of the magnetic disk and the fixed permanent magnets of the magnetic gyroscope elements. It should be understood that the fixed permanent magnets may alternately be supported upon other suitable structures. For example, if the upper and lower shell portions are structurally adequate, the shell portions (see FIG. 4) may support fixed permanent magnets. In order to facilitate the lifting and other movements of the base platform of the invention, a control and power module is provided, and fixed or coupled to the base platform. The control and power module is also operatively coupled to regulate and control a spin rate and spin direction of each of the anti-gravity clusters, which will enable a desired motion and propulsion of the propulsion platform. For example, in a preferred embodiment of the anti-gravity propulsion platform, the control and power module may be utilized to establish a first cluster group, which is provided by a plurality of anti-gravity clusters spinning in a first direction, and a second cluster group that is provided by a plurality of anti-gravity clusters spinning in an second, opposite direction. By controlling the direction of rotation (spin direction) and the spin rate, the control and power module enables the propulsion platform to be maneuvered in a controlled fashion.

To further facilitate the controlled maneuvering of the propulsion platform of the invention, direction controlling elements may be provided. The direction controlling elements would include at least one magnetic gyroscope element that is supported by an adjustable support structure that would enable a rotational axis to be altered or tilted in a controlled manner, thereby causing a direction altering force to be applied to the propulsion platform.

### BRIEF DESCRIPTION OF THE DRAWINGS

In the drawings, like elements are assigned like reference numerals. It must be understood that each of the embodiments depicted are but one of a number of possible arrangements utilizing the fundamental concepts of the present invention. The drawings are briefly described as follows:

FIG. 1 a simplified perspective view of an anti-gravity propulsion platform, including a gyroscopic propulsion system with a plurality of anti-gravity clusters of the invention;

FIG. 2 provides a high level block diagram an embodiment of a gyroscopic propulsion system in accordance with FIG. 1.

FIGS. 3A and 3B illustrate, respectively, a top view and a bottom view of an anti-gravity cluster having a plurality of angled or tilted magnetic gyroscope elements coupled thereto.

FIG. 4 depicts a partially exploded view of magnetic gyroscope element of an anti-gravity cluster.

FIG. 5A shows a detailed view of an internal embodiment of a magnetic gyroscope element in accordance with the invention.

FIG. 5B is a partial sectional top view of portions of the magnetic gyroscope element, including a magnetic disk thereof, taken along the lines 5B-5B of FIG. 5A.

FIG. 6 provides a high level block diagram of a remote control embodiment of the invention.

FIG. 7A depicts a simplified block diagram of a direction controlling element structured with at least one magnetic gyroscope element, which may be employed upon the propulsion platform to enable the direction of the platform to be altered in a controlled manner.

FIG. 7B conceptually illustrates a tilting action that may be produced by an adjustable support structure of a direction controlling element of the invention.

Partial List Of Reference Numerals

| | |
|---|---|
| 18 | anti-gravity propulsion platform |
| 20 | base platform (chassis) |
| 24 | anti-gravity cluster |
| 26a | first cluster group |
| 26b | second cluster group |
| 28 | magnetic gyroscope element |
| 28a | magnetic disk (of 28) |
| 28aa | outer rim portion of magnetic disk 28a |
| 28b | circumferential support members |
| 28c | (fixed) permanent magnets of 28 |
| 28d | (rotating) permanent magnets of 28a |
| 28e | shaft |
| 29a | upper shell portion |
| 29b | lower shell portion |
| 30 | communication module |
| 32 | control and power module |
| 34 | cluster spinner (motor) |
| 36 | control and interface module |
| 38 | control coupling |
| 40 | (high capacity) power source |
| 42 | annular ring of magnets |
| 46 | cluster support members |
| 50 | cluster disk |
| 50a | outer rim portion (of 50) |
| 54 | cluster disk bearing |
| 58 | adjustable support structure |
| 60 | remote control unit |
| 64 | remote link |
| 70a | first orientation or angle |
| 70b | second tilted orientation or angle |
| 80 | direction controlling or altering element |

### DETAILED DESCRIPTION AND MODES OF THE INVENTION

It is important to establish the definition of several terms and expressions that will be used throughout this disclosure. The term ‘spin rate’ is to be defined as a measure of rotational speed, which may, for example, be expressed in revolutions per second (RPS) or revolution per minute (RPM). The term ‘spin direction’ is to be defined as a direction of rotation or a rotational direction as applied to any rotatably mounted portions or structures of the present invention. The term platform, as employed when describing a propulsion platform of the present invention, may most preferably be configured as a complicated chassis that is composed of numerous constituent members. Other important terms and definitions will be provided as they are needed, to properly and concisely define the present invention and its associated novel characteristics and features.

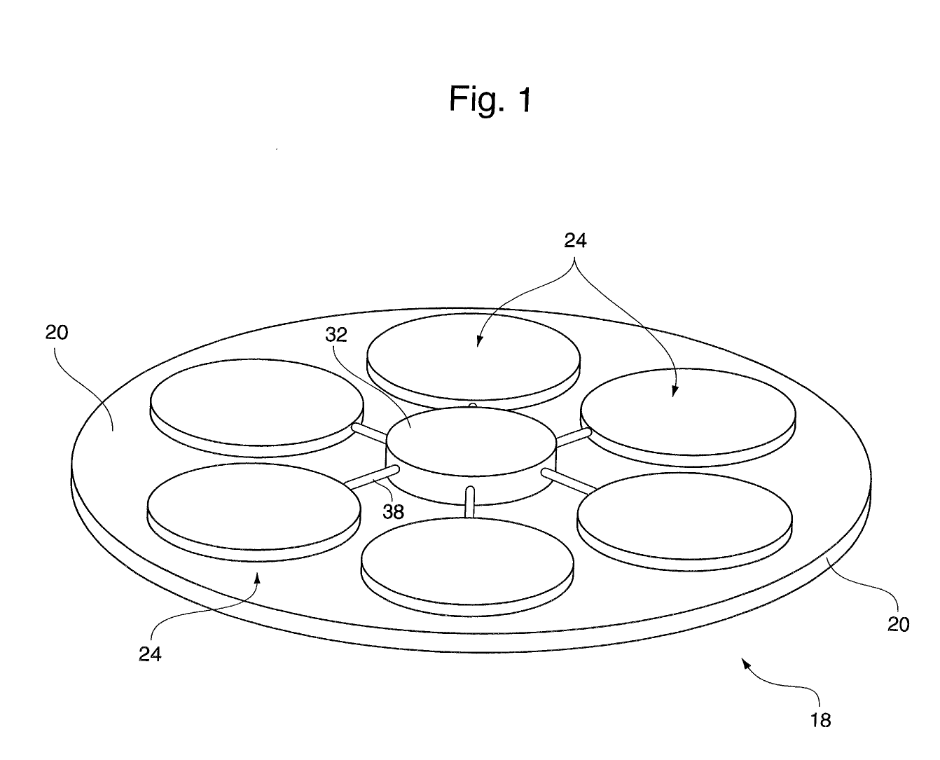

Referring now to the drawings, FIG. 1 depicts an anti-gravity propulsion platform 18, which may also be termed an anti-gravity matrix structure. A base platform 20 is provided, preferably having a substantially flattened lower structure as seen from a side view, and circular outline when observed from the top view location. The base platform 20 is arranged to support the lifting, maneuvering, and transport of additional structures and masses fixed to the base platform. These additional structures may include additional operational components of the propulsion platform 18, as well as cargo and individuals to be transported. In the case of a small scale version of the invention, the additional structures and masses may most preferably be limited to including only operational components of the propulsion platform 18.

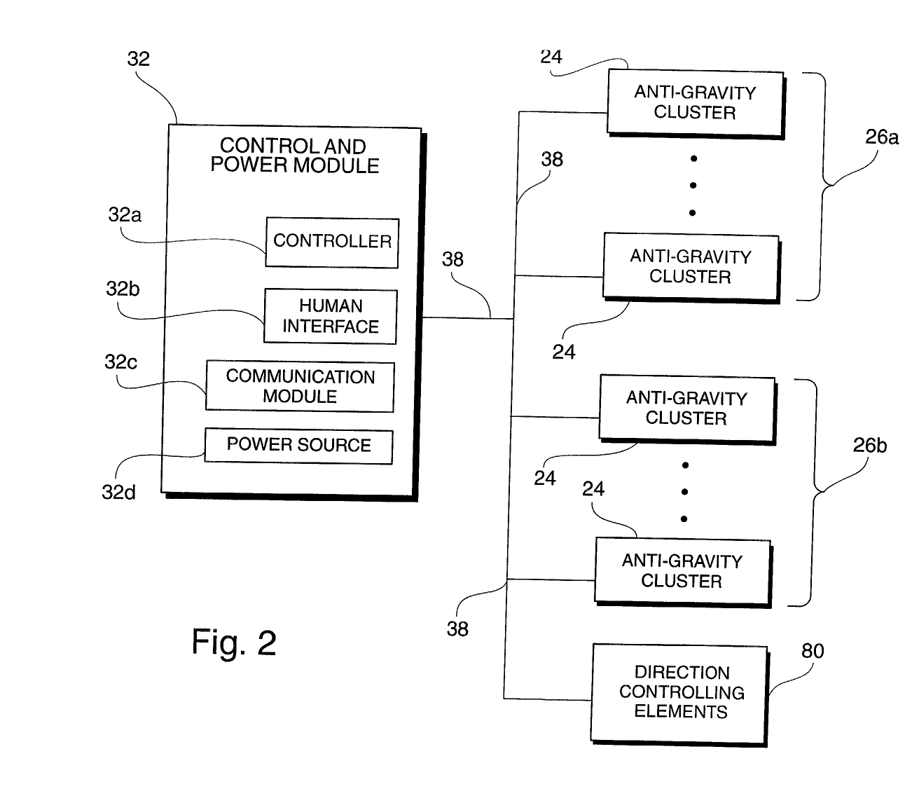

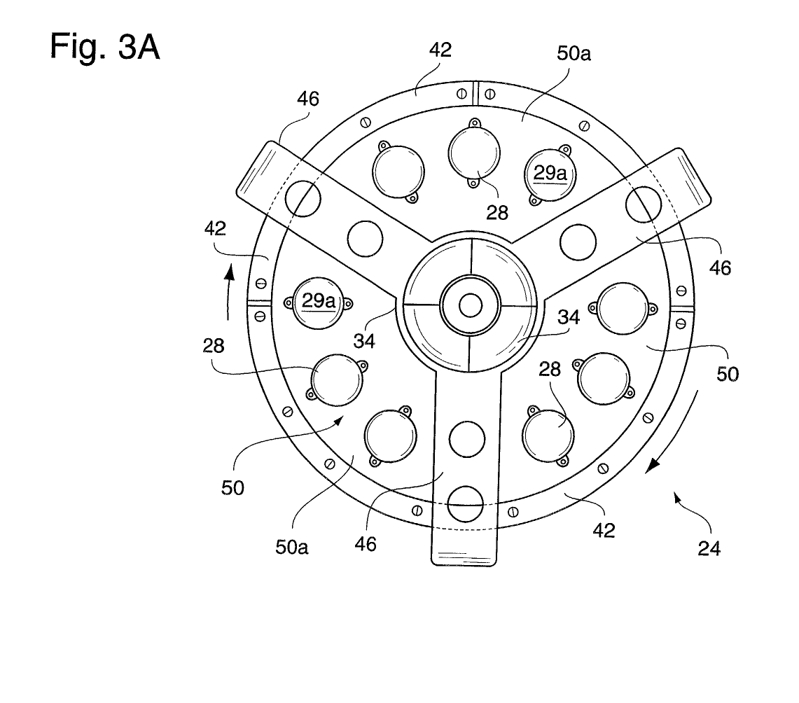

As can be seen in FIGS. 1 and 2, a plurality of spaced anti-gravity clusters 24 are uniformly positioned with equal spacing in an annular relationship. Most preferably, each of the anti-gravity clusters is positioned at an equi-distant radius from a center location of the base platform. The center location may be provided as a center of mass, a center of gravity, or another suitable selected location near a center region of the base platform 20. As can be seen in FIGS. 3A and 3B, each anti-gravity cluster is structured to include a cluster disk 50 that is rotatably mounted. As such, the cluster disks 50 are suitably rotatably mounted and fixed to the base platform 20. As illustrated, cluster support members 46 may most preferably be provided to enable the cluster disk 50 to be suitable mounted and rotated in one of either a clockwise or a counter clockwise direction about a rotational axis. The rotational axis is oriented so as to be substantially orthogonal to a plane established by the base platform 18. As FIGS. 3A and 3B depict a top view and a bottom view of an anti-gravity cluster 24, respectively, the rotational axis would be provided orthogonal to a plane established by the page of these figures.

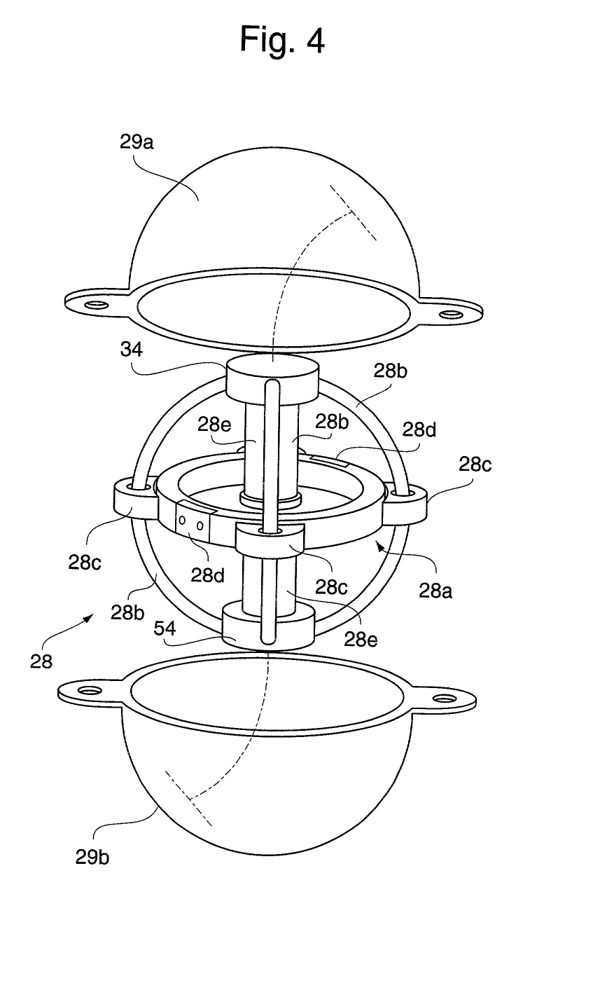

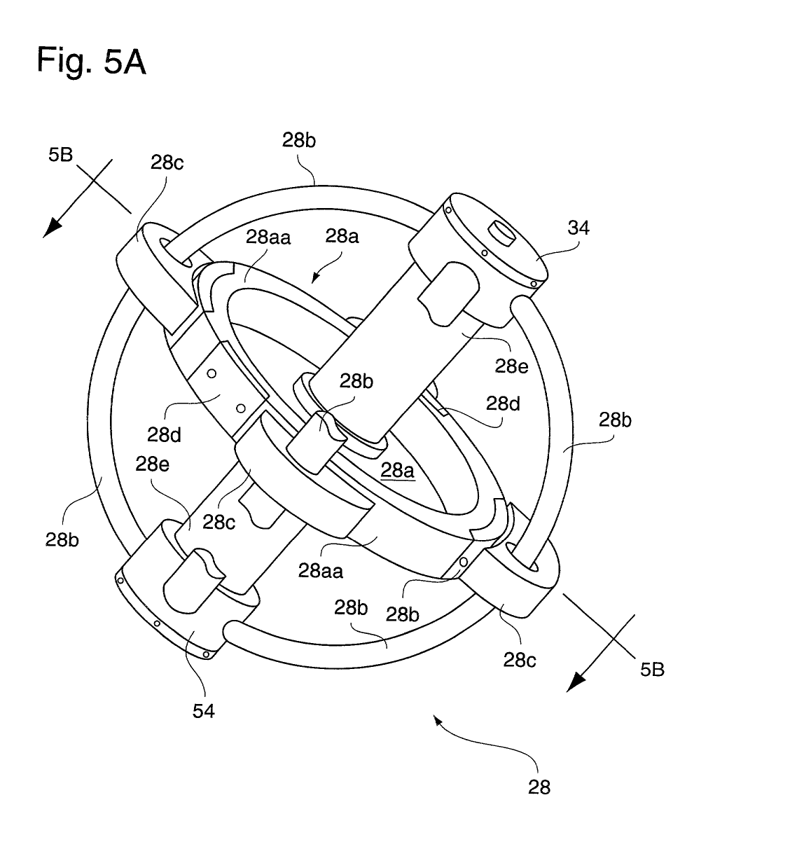

Each anti-gravity cluster 24 further includes a plurality of magnetic gyroscope elements 28 that are themselves arranged in annular relationship at an equi-distant radius from a center location of the cluster disk 50. The magnetic gyroscope elements are suitably fixed to the cluster disk such that each magnetic gyroscope element is aligned and oriented substantially at a 45 degree angle between a plane of the cluster disk 50 and a rotational axis of each magnetic gyroscope element. The term aligned and oriented most preferably further indicates that each rotational axis of each magnetic gyroscope element is oriented substantially in the same direction with an equivalent tilt angle and direction. For example, each magnetic gyroscope may be most preferably be oriented as shown in FIG. 5A at a common tilt angle with respect to an orientation of the base platform.

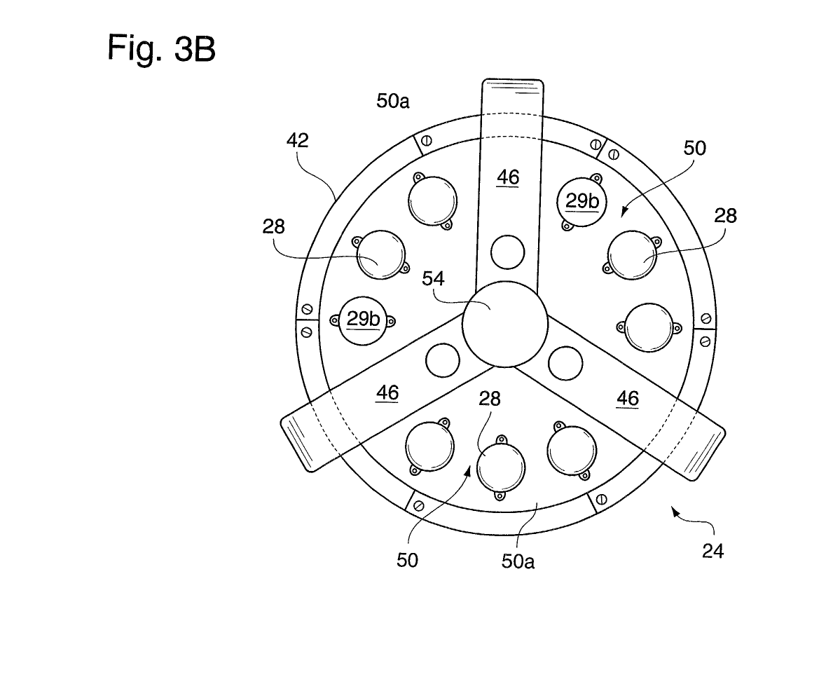

As can be seen most clearly in FIGS. 4 and 5A, each magnetic gyroscope element 28 is composed of a number of constituent components. A magnetic disk 28a is included that is rotatably supported upon a shaft 28e. The shaft and associated means may be supported within the magnetic gyroscope element by a plurality of circumferential support members 28b, or equivalently functional structures. Also required are suitable bearing means 54 and arrangements to enable the shaft 28e to freely rotate about the rotational axis of the magnetic disk 28a of the magnetic gyroscope element 28. Suitable bearing arrangements and means employable to rotatably support the magnetic disks 28a are known and providable by skilled persons. As further shown in FIGS. 4 through 5B, a plurality of permanent magnets 28c are situated at spaced locations around an outer rim portion 28aa of the magnetic disk 28a. It may be noted that an alternate configuration may provide for a larger number of permanent magnets 28c, or possibly a monolithic annular magnet, provided and situated adjacent to and just outside of the outer rim portion 28aa of the magnetic disk 28a.

A second plurality of fixed permanent magnets 28c, each of which may be fixed to a circumferential support member 28b of the magnetic gyroscope element 28 at spaced locations about the circumference of the magnetic disk 28a. As illustrated each circumferential support member 28b is positioned adjacent to, and just outside of, the magnetic disk 28a of the magnetic gyroscope element 28, at circumferentially spaced locations. Importantly, as illustrated in FIG. 5B, permanent magnets 28c may be shaped to increase operational efficiency of the magnetic gyroscope elements 28. This shaping may provide for permanent magnets 28c having a narrow end 28ca, and an blunt or wide end 28cb. Also, the narrow end 28ca may be elongated an extended, as illustrated. It must be understood that the magnetic sources of the magnetic gyroscope elements 28, including permanent magnets 28c and 28d, are arranged with a magnetic alignment selected so that magnetic repulsion forces cause the magnetic disk 28a to rotate, preferably in a counter clockwise direction, with little or no external outside excitation.

Returning to FIG. 4, an upper shell portion 29a and lower shell portion 29b, or equivalent functional structures, may be included to house, support, and enable the fixing of the magnetic gyroscope elements 28 to the cluster disk 50. The upper shell portion 29a and lower shell portion 29b may be best provided by a magnetically transparent materials such as fiber glass and or available reinforced synthetic polymer materials.

As shown in FIGS. 1, 2, and 6, the present invention includes a control and power module 32, or a plurality of functionally equivalent modules, supported upon the base platform 20. The control and power module 32 is operatively coupled to control a spin rate and direction of rotation of the anti-gravity clusters 24 to produce a desired lifting effect and motion of the base platform 20. The desired motion, and maneuvering and propulsion of the anti-gravity propulsion platform 18, is realized by the phenomenon of gyroscopic precession as produced by the rotation of the cluster disks, which as discussed above, cause the magnetic gyroscope elements 28, which are mounted at substantially a forty-five (45) degree angle thereto, to change direction and develop motion based on the principle of gyroscopic precession. As know to skilled persons, the goal when gyroscopic precession is involved, is always to maximize the efficiency with which rotational energy is translated or converted into linear motion.

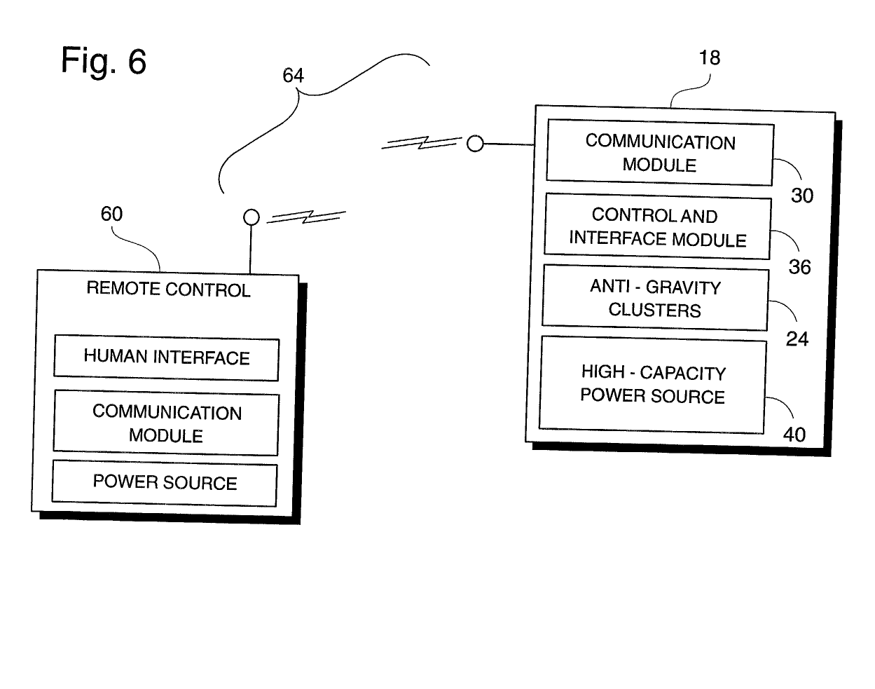

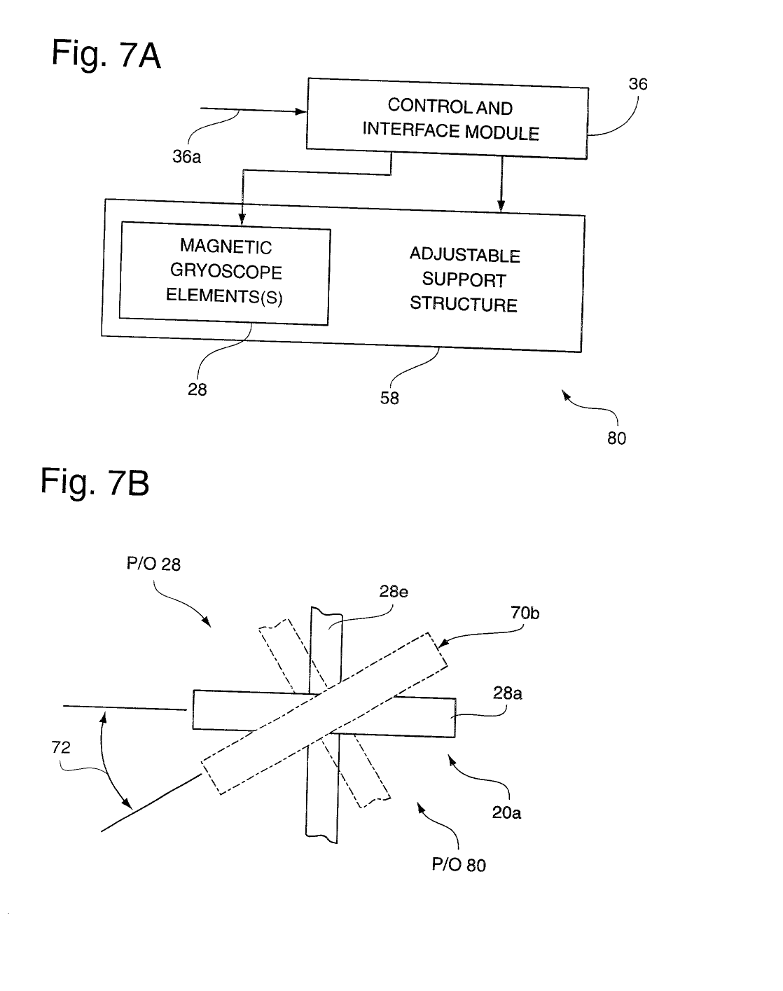

As depicted in FIG. 2, a most preferred embodiment of the present invention is contemplated two employ at least two distinct groups of anti-gravity clusters. A first group, which may be termed ‘a first cluster group’, is provided by a plurality of anti-gravity clusters that spin in a first direction, which may be alternately termed a first rotational direction. A second group, which may be termed ‘a second cluster group’, is provided by a plurality of anti-gravity clusters that spin in an second, opposite direction. For example, the respective spin directions or direction of rotations of each of the first group and the second group, may be clockwise and counter clockwise, respectively. By varying the spin rate of the anti-gravity cluster disks 50, as well as the spin rates of the magnetic disks 28a of the magnetic disk elements 28, the controlled lifting and maneuvering of propulsion platform 20 may be realized. Additional maneuvering means may be provided that includes a plurality of direction controlling elements or modules 80, which will be additionally discussed when referring to FIGS. 7A and 7B. As best seen in FIGS. 3A and 5A, each anti-gravity cluster 24 of the propulsion platform 18 includes a cluster spinner 34. The cluster spinner 34 may be most preferably provided by an efficient electric motor. Each cluster spinner, which is responsive to the control and power module 32, is configured to control the spin rate and spin direction of each cluster disk 50. As illustrated, a cluster spinner 34 is directly coupled to the cluster disk 50 via shaft 28e. Alternately, a transmission and or gear reduction arrangement maybe provided.

As depicted in FIGS. 3A and 3B, each anti-gravity cluster 24 may further include an annular ring of magnets 42, which are located at a selected radial distance from a center location of the anti-gravity cluster 24. The annular ring of magnets 42 may most preferably be located just outside of, and immediately adjacent to, an outer edge 50a of the cluster disk 50. Therefore, as depicted, the annular ring of magnets 42 may be positioned within a plane established by the cluster disk. It is contemplated that 42 may be provided as a monolithic ring magnet.

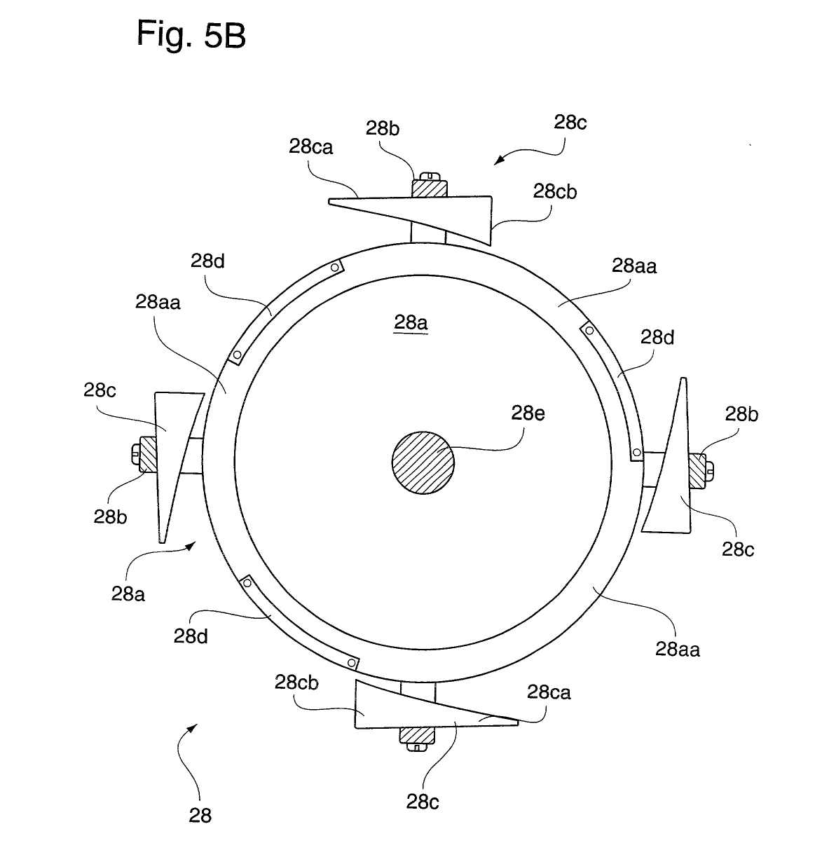

Turning to FIG. 6, a high level block diagram of a remote controllable embodiment of the invention is provided. As shown, in the illustrated embodiment, the anti-gravity propulsion platform 18 may be configured with a communications module 30 to receive and possibly exchange information with a remote control unit 60. The remote control unit 60 will enable information, including flight altering commands, to be sent to the propulsion platform 18. It may be noted that the remote control unit may be provided input from an operator or a computer. The received commands and other information would be communicated to a control and interface module 36. The control and interface module 36 is contemplated to enable the received information to be processed and applied to control the operation of the anti-gravity clusters. Accordingly, a high capacity power supply 40, which may be provided as a portion of a control and power module or an equivalent structure, would be arranged to be responsive to the control and interface module, as required, to adjust operating parameters of the antigravity clusters 24. These operating parameters may include items such as the spin rate, spin direction, etc.

The remote control unit 60 may be provided in a number of functional embodiments. For example, as depicted in FIG. 6, the remote control unit 60 may include a human interface to enable an operator to input flight altering commands. Such a remote control unit 60 may be operatively coupled to the propulsion platform 18 by way of a remote link 64. The remote link 64 may be established by any suitable wireless arrangement known in the art. An alternate remote control arrangement may include a means to support the issuing of a sequence of pre-determined flight altering commands. For example, a remote computer may be employed to issue a sequence of pre-programmed flight related or altering commands.

Referring now to FIGS. 7A and 7B, a means to facilitate the controlled maneuvering of the propulsion platform 18 of the invention will be discussed. If included, this means, which may be termed ‘direction controlling elements’, ‘directional gyroscopes’, etc., would include at least one magnetic gyroscope element 28. Each magnetic gyroscope element 28 is supported by an adjustable support structure 58 that would enable the orientation of a rotational axis of the magnetic gyroscope element 28 to be altered or tilted in a controlled manner. For example, as depicted in FIG. 7B, a magnetic disk 28a of a magnetic gyroscope element 28 may be tilted from a first tilt orientation 70a to a second tilt orientation 70b. Skilled persons will appreciate that know gyroscopic phenomenon dictate that the tilting of a magnetic disk 28a, which is assumed to be spinning at a selected spin rate within the magnetic gyroscope element, will cause a direction altering force to be developed. Accordingly, the adjustable support structure 58 is structured to tilt a magnetic disk 28a of magnetic gyroscope element 28 in order to cause a direction altering force to be applied to the propulsion platform 18. As such, by selectively tilting and righting one or more magnetic gyroscope element’ magnetic disks, the propulsion platform may be maneuvered in a desired and controlled manner. It may be noted that the direction altering elements 80 are to be most preferably fixed to and located near a perimeter of the base platform. In a most preferred embodiment the direction altering elements may be supported by secondary structures (not illustrated) that are providable by skilled persons.

Returning to FIG. 7A, an control and interface module 36 may be included with the direction altering element to enable control commands to be received via link 36a. These commands may be applied by the control and interface module 36 to vary the spin rate of the magnetic gyroscope element 28 and alter the tilt angle via the adjustable support structure 58.

While there have been described a plurality of the currently preferred embodiments of the present invention, those skilled in the art will recognize that other and further modifications may be made without departing from the invention and it is intended to claim all modifications and variations as fall within the scope of the invention and the appended claims.

What is claimed is:

1. An anti-gravity propulsion platform structured to enable a base platform and additional structures and masses fixed to the base platform to rise and maneuver in a controlled manner, the propulsion platform comprising:
a) the base platform, configured having a substantially flattened and circular shape;
b) a plurality of spaced anti-gravity clusters uniformly positioned with equal spacing in annular relationship, with each anti-gravity cluster mounted at an equi-distant radius from a center location of the base platform;
c) each anti-gravity cluster having a cluster disk that is rotatably fixed to the base platform to enable the cluster disk to be rotated in one of either a clockwise or a counter clockwise direction about a rotational axis that is substantially orthogonal to a plane established by the base platform;
d) each anti-gravity cluster further including a plurality of magnetic gyroscope elements that are arranged in annular relationship at an equi-distant radius from a center location of each cluster disk and fixed to the cluster disk such that a rotational axis of each magnetic gyroscope element is aligned and oriented substantially at a 45 degree angle between a plane of the cluster disk and a rotational axis of each magnetic gyroscope element; and
e) a control and power module coupled to the base platform and operatively coupled to control a spin rate and spin direction of the anti-gravity clusters to produce desired lifting and maneuvering of the propulsion platform.

2. The anti-gravity propulsion platform in accordance with claim 1, wherein each magnetic gyroscope element includes:
a) a magnetic disk which is rotatably supported within the magnetic gyroscope element, the rotational axis of each magnetic gyroscope element being established by a rotational axis of each magnetic disk thereof;
b) a plurality of permanent magnets situated at spaced locations around an outer rim portion of the magnetic disk, each permanent magnet fixed to the outer rim portion at the spaced locations;
c) a plurality of fixed permanent magnets, each fixed to a support member of the magnetic gyroscope element at spaced locations and positioned adjacent to the magnetic disk of the magnetic gyroscope elements.

3. The anti-gravity propulsion platform in accordance with claim 2, wherein the plurality of permanent magnets forms a magnetic ring.

4. The anti-gravity propulsion platform in accordance with claim 1, wherein a first cluster group is provided by a plurality of anti-gravity clusters that spin in a first direction and a second cluster group is provided by a plurality of anti-gravity clusters that spin in an second, opposite direction.

5. The anti-gravity propulsion platform in accordance with claim 4, further including a plurality of direction altering elements, each located near a perimeter of the base platform and provided to support altering and controlling the maneuvering of the propulsion platform.

6. The anti-gravity propulsion platform in accordance with claim 1, wherein the control and power module is arranged to selectively adjust and control the spin rates of each of the anti-gravity clusters and each direction altering element.

7. The anti-gravity propulsion platform in accordance with claim 6, wherein each anti-gravity cluster includes a cluster spinner that is operatively coupled to and controllable by the control and power module.

8. The anti-gravity propulsion platform in accordance with claim 7, wherein each anti-gravity cluster further includes an annular ring of magnets located at a selected radial distance from a center location of an anti-gravity cluster, just outside of and adjacent to an outer rim portion of the cluster disk, the annular ring of magnets positioned substantially with a plane established by the cluster disk.

9. The anti-gravity propulsion platform in accordance with claim 1, wherein the operation and propulsion of the propulsion platform results from information and commands received from a remote control means operated by an operator.

10. The anti-gravity propulsion platform in accordance with claim 9, wherein the remote control means exchanges information and commands with the control and power module by way of a wireless communication link.

11. An anti-gravity propulsion platform, comprising:
a) a base platform having a substantially flattened form, the base platform structured with a plurality of openings, the openings uniformly positioned in annular relationship at an equi-distant radius from a center location of the base platform;
b) a plurality of spaced anti-gravity clusters each sized to and fixed within an opening of the base platform, each anti-gravity cluster structured with:
i) a cluster disk, having a substantially circular perimeter, the cluster disk rotatably fixed to the base platform to enable the cluster disk to be rotated in one of either a counter clockwise or a clockwise direction, and having a rotational axis that is substantially orthogonal to a plane established by the base platform;
ii) each cluster disk having fixed thereto a plurality of magnetic gyroscope elements that are arranged in an annular relationship at an equi-distant radius from a center location of the cluster disk, with each magnetic gyroscope element oriented substantially with a 45 degree angle between a plane of the cluster disk and a rotational axis of the magnetic gyroscope element;
iii) a cluster spinner that is structured to spin the cluster disk and the magnetic gyroscope elements fixed thereto at a selected spin rate in either of a clockwise direction or a counter clockwise direction, the cluster spinner operatively coupled to a control and power module to enable adjustment and control of the spin rate of each cluster disk of anti-gravity clusters;
c) the control and power module supported upon the base platform and operatively coupled to control a spin rate and direction of rotation of each cluster disk of an anti-gravity cluster.

12. The anti-gravity propulsion platform in accordance with claim 11, wherein each magnetic gyroscope element comprises:
a) a magnetic disk which is rotatably supported by support members within a shell structure of the magnetic gyroscope element;
b) a plurality of permanent magnets situated at spaced locations around an outer rim portion of the magnetic disk;
c) a plurality of fixed permanent magnets, each fixed to a circumferential support member of the magnetic gyroscope element establishing spaced perimeter locations around an outside perimeter of, and positioned adjacent to, a rim portion of the magnetic disk.

13. The anti-gravity propulsion platform in accordance with claim 12, wherein a first cluster group is provided by a plurality of anti-gravity clusters that spin in a first direction and a second cluster group is provided by another plurality of anti-gravity clusters that spin in a second direction.

14. The anti-gravity propulsion platform in accordance with claim 13, wherein the control and power module is arranged to selectively adjust and control the spin rates and spin direction of each of the anti-gravity clusters.

15. The anti-gravity propulsion platform in accordance with claim 14, wherein each anti-gravity cluster further includes an annular ring of permanent magnets located at a radial distance from a center location of an anti-gravity cluster, just outside of and adjacent to an outer edge of the cluster disk thereof, the annular ring of permanent magnets substantially positioned proximate to and parallel to a plane established by the cluster disk.

16. The anti-gravity propulsion platform in accordance with claim 15, further including a plurality of direction altering elements, with each respective direction altering element located near a perimeter of the base platform.

17. The anti-gravity propulsion platform in accordance with claim 16, wherein each direction altering element includes at least one magnetic gyroscope element supported by an adjustable support structure enabling the tilt orientation of a rotational axis of a magnetic disk of the magnetic gyroscope element to be altered and tilted in a controlled manner from a first tilt orientation to a second tilt orientation, thereby causing a direction altering force to be developed and applied to the propulsion platform.
